(19) United States
(12) Patent Application Publication
(10) Pub. No.: US 2016/0020024 A1
(43) Pub. Date: Jan. 21, 2016

(54) COMPOSITE ELECTRONIC COMPONENT AND BOARD HAVING THE SAME

(71) Applicant: SAMSUNG ELECTRO-MECHANICS CO., LTD., Suwon-Si (KR)

(72) Inventors: Hong Kyu SHIN, Suwon-Si (KR); Hyun Sub OH, Suwon-Si (KR); Jae Hyuk CHOI, Suwon-Si (KR)

(21) Appl. No.: 14/634,677

(22) Filed: Feb. 27, 2015

(30) Foreign Application Priority Data
Jul. 18, 2014 (KR) 10-2014-0091293
Oct. 8, 2014 (KR) 10-2014-0136011

(51) Int. Cl. H01G 4/12; H01G 2/06; H01G 4/248; H01G 4/012; H01G 4/30; H01G 9/052

(52) U.S. Cl. CPC H01G 4/12; H01G 4/30; H01G 9/052; H01G 4/248; H01G 4/012; H01G 2/065

(57) ABSTRACT

A composite electronic component includes: an insulating sheet; connection conductor parts disposed on one or more of upper and lower surfaces of the insulating sheet; a composite body disposed on the insulating sheet and including a tantalum capacitor and a multilayer ceramic capacitor (MLCC) coupled to each other; a molding part disposed to enclose the composite body; and a positive electrode terminal disposed on a first side surface of the molding part in a length direction of the molding part and a lower surface of the molding part and a negative electrode terminal disposed on a second side surface of the molding part in a length direction of the molding part and the lower surface of the molding part.

### CROSS-REFERENCE TO RELATED APPLICATIONS

This application claims the priorities and benefits of Korean Patent Application Nos. 10-2014-0091293 filed on Jul. 18, 2014 and 10-2014-0136011 filed on Oct. 8, 2014, with the Korean Intellectual Property Office, the disclosures of which are incorporated herein by reference.

### BACKGROUND

The present inventive concept relates to a composite electronic component including a plurality of passive elements and a board having the same.

A multilayer ceramic capacitor (MLCC), a multilayer chip electronic component, is a chip-type condenser mounted on the printed circuit boards (PCBs) of various types of electronic products, such as image display devices including liquid crystal displays (LCDs), plasma display panels (PDPs), and the like, as well as computers, smartphones, cellular phones, and the like, serving to charge electricity therein as well as to discharge electricity therefrom.

Such multilayer ceramic capacitors may be used as components in various types of electronic devices, due to advantages thereof such as a relatively small size, high capacitance, and ease in the mounting thereof.

Multilayer ceramic capacitors may have a structure in which a plurality of dielectric layers and internal electrodes disposed between the dielectric layers and having different polarities are stacked in an alternating manner.

Since the dielectric layer has piezoelectric and electrostrictive characteristics, a piezoelectric phenomenon may occur between the internal electrodes when a direct current (DC) or alternating current (AC) voltage is applied to a multilayer ceramic capacitor, such that vibrations may be generated.

These vibrations may be transferred to a printed circuit board (PCB) on which the multilayer ceramic capacitor is mounted through solders of the multilayer ceramic capacitor, such that the entire PCB may become a sound radiating surface generating vibrational sound, commonly known as noise.

The vibrational sound may correspond to noise within an audio frequency range of 20 to 20000 hertz (Hz), sound which may cause discomfort to listeners thereof. Vibrational sound causing listener discomfort, as described above may be termed acoustic noise.

Research into a product having a form in which an area of a lower cover layer of the multilayer ceramic capacitor is increased in order to decrease acoustic noise has been conducted.

However, research into a product having an improved acoustic noise reduction effect is further required.

### RELATED ART DOCUMENT

Japanese Patent Laid-Open Publication No. 1997-326334

### SUMMARY

An aspect of the present inventive concept may provide a composite electronic component having an excellent acoustic noise reduction effect.

An aspect of the present inventive concept may also provide a composite electronic component having relatively low equivalent series resistance (ESR)/equivalent series inductance (ESL), improved direct current (DC)-bias characteristics, and a relatively low chip thickness.

According to an aspect of the present inventive concept, a composite electronic component may include a composite body including a tantalum capacitor and a multilayer ceramic capacitor (MLCC) coupled to each other, wherein the tantalum capacitor includes a tantalum wire embedded in a body part of the tantalum capacitor to be offset towards one side of the body part of the tantalum capacitor, and the multilayer ceramic capacitor is disposed in a space between one surface of the body part through which the tantalum wire is led out and the tantalum wire exposed from the body part sufficiently provided by a structure in which the tantalum wire is offset to improve space efficiency.

According to another aspect of the present inventive concept, a board having a composite electronic component may include: a printed circuit board (PCB) having electrode pads disposed thereon; the aforementioned composite electronic component mounted on the PCB; and solders connecting the electrode pads and the composite electronic component to each other.

### BRIEF DESCRIPTION OF DRAWINGS

The above and other aspects, features and other advantages of the present inventive concept will be more clearly understood from the following detailed description taken in conjunction with the accompanying drawings, in which:

FIG. 1 is a perspective view illustrating an electrode terminal and a molding part of a composite electronic component according to an exemplary embodiment of the present inventive concept;

FIG. 2 is a cross-sectional view taken along line A-A′ of FIG. 1;

FIG. 3 is a cross-sectional view taken along line B-B′ of FIG. 1;

FIG. 4 is a cross-sectional view of a composite electronic component illustrating a modified example of a connection conductor part of a composite electronic component according to an exemplary embodiment of the present inventive concept;

FIGS. 5A and 5B are enlarged views of regions C1 and C2 of FIG. 3;

FIG. 6 is a perspective view schematically illustrating a composite electronic component according to another exemplary embodiment of the present inventive concept;

FIGS. 7A and 7B are graphs illustrating equivalent series resistance (ESR) versus a frequency of a composite electronic component according to Inventive Example and Comparative Example, and impedance versus a frequency of a composite electronic component according to Inventive Example and Comparative Example, respectively;

FIG. 8 is a graph illustrating an output voltage versus time according to Inventive Example and Comparative Example;

FIG. 9 is a graph illustrating a voltage ripple (ΔV) versus ESR based on a volume ratio between a multilayer ceramic capacitor (MLCC) and a tantalum capacitor in a composite electronic component according to an exemplary embodiment of the present inventive concept; and

FIG. 10 is a perspective view illustrating a form in which the composite electronic component of FIG. 1 is mounted on a printed circuit board (PCB).

### DETAILED DESCRIPTION

Exemplary embodiments of the present inventive concept will now be described in detail with reference to the accompanying drawings.

The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art.

In the drawings, the shapes and dimensions of elements may be exaggerated for clarity, and the same reference numerals will be used throughout to designate the same or like elements.

Directions of a hexahedron will be defined in order to clearly describe exemplary embodiments of the present inventive concept. L, W and T shown in the accompanying drawings refer to a length direction, a width direction, and a thickness direction, respectively.

Composite Electronic Component

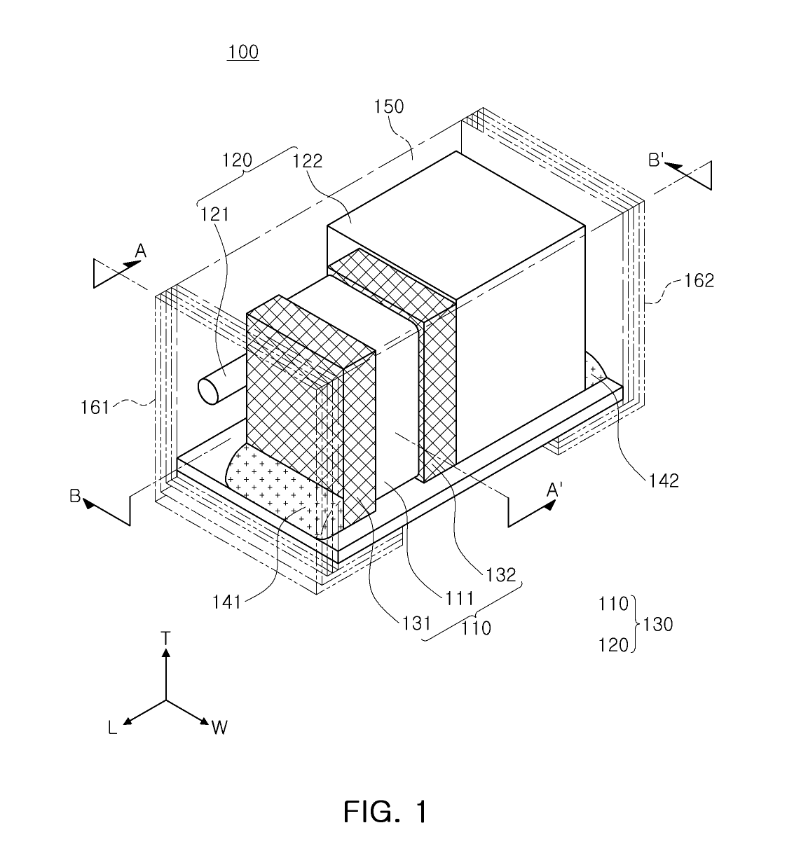

FIG. 1 is a perspective view illustrating electrode terminals and a molding part of a composite electronic component according to an exemplary embodiment of the present inventive concept;

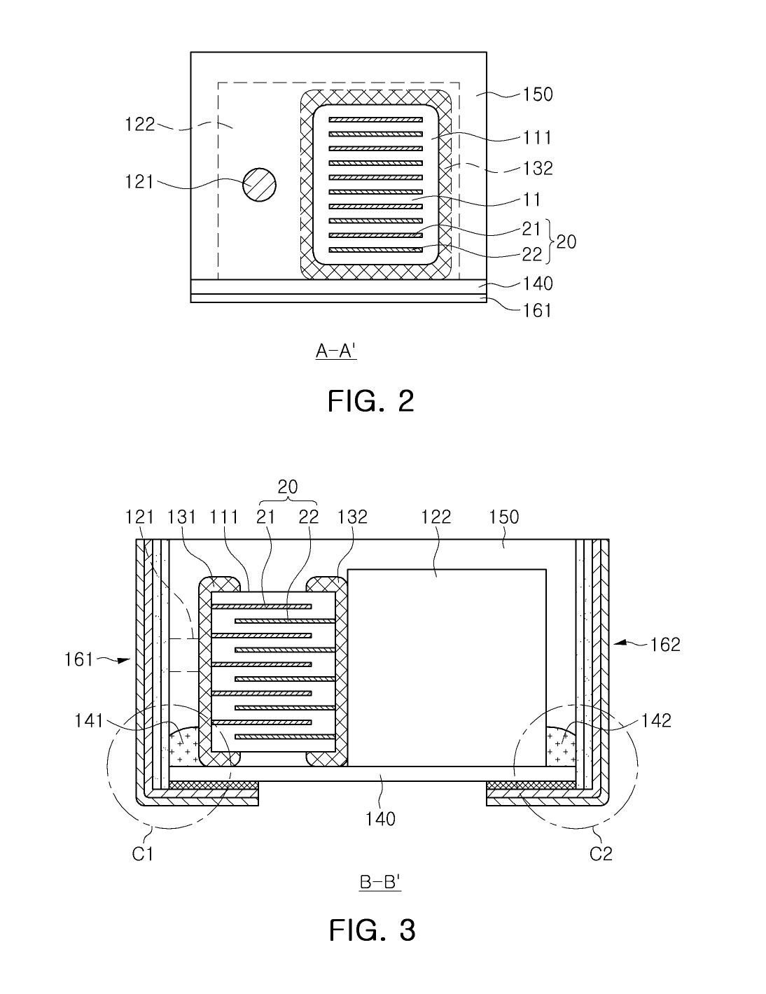

FIG. 2 is a cross-sectional view taken along line A-A′ of FIG. 1; and FIG. 3 is a cross-sectional view taken along line B-B′ of FIG. 1.

Referring to FIGS. 1 through 3, a composite electronic component 100 according to an exemplary embodiment of the present inventive concept may include an insulating sheet 140, a composite body 130 disposed on an upper surface of the insulating sheet 140 and including a multilayer ceramic capacitor (MLCC) 110 and a tantalum capacitor 120, a molding part 150, and electrode terminals 161 and 162.

The electrode terminals 161 and 162 may include a positive electrode terminal 161 and a negative electrode terminal 162.

The multilayer ceramic capacitor 110 is not particularly limited, but may use various types of multilayer ceramic capacitors.

For example, the multilayer ceramic capacitor 110 may include a ceramic body 111 in which a plurality of dielectric layers 11 and internal electrodes 20 disposed with each of the dielectric layers interposed therebetween are stacked, and external electrodes 131 and 132 formed on respective outer surfaces of the ceramic body to be connected to the internal electrodes.

The internal electrodes 20 may include first and second internal electrodes 21 and 22 that may be alternatingly disposed on the dielectric layers with each of the dielectric layers 11 interposed therebetween.

The first internal electrodes may be exposed through a first side surface of the ceramic body, and the second internal electrodes may be exposed through a second side surface of the ceramic body.

The ceramic body 111 may be formed by stacking and then sintering the plurality of dielectric layers and the internal electrodes.

In addition, the dielectric layer 11 may contain ceramic powder having a high-k, for example, barium titanate (BaTiO₃) based powder or strontium titanate (SrTiO₃) based powder. However, the type of powder contained in the dielectric layer 11 is not limited thereto.

A material forming the first and second internal electrodes 21 and 22 is not particularly limited, and may be a conductive paste formed of at least one selected from the group consisting of, for example, a noble metal material such as palladium (Pd), a palladium-silver (Pd—Ag) alloy, or the like, nickel (Ni), and copper (Cu).

The external electrodes 131 and 132 may be disposed on the outer surfaces of the ceramic body 111, respectively, and may be electrically connected to the internal electrodes. The external electrodes may include first and second external electrodes 131 and 132. The first external electrode 131 may be electrically connected to the first internal electrodes 21, and the second external electrode 132 may be electrically connected to the second internal electrodes 22.

According to an exemplary embodiment of the present inventive concept, nickel/tin (Ni/Sn) plating layers may not be disposed on the first and second external electrodes 131 and 132 unlike in a case of a general multilayer ceramic capacitor.

Since the composite electronic component includes the molding part 150 disposed to enclose the composite body 130 disposed on the upper surface of the insulating sheet 140 and including the multilayer ceramic capacitor 110 and the tantalum capacitor 120, as will be described hereinbelow, the plating layers do not need to be formed on the first and second external electrodes 131 and 132 of the multilayer ceramic capacitor 110.

Therefore, an issue of reliability being decreased due to permeation of a plating solution into the ceramic body 111 of the multilayer ceramic capacitor 110 may be prevented.

The tantalum capacitor 120 may include a body part 122 and a tantalum wire 121, wherein the tantalum wire 121 may be embedded in the body part 122 so that a portion of the tantalum wire 121 in a length direction of the body part 122 is exposed through one surface of the body part 122.

The body part 122 of the tantalum capacitor 120 may include a positive electrode body, a dielectric layer, a solid electrolyte layer, a carbon layer, and a negative electrode layer, but the layer to be included in the body part is not limited thereto.

The positive electrode body may be formed of a porous material formed of sintered tantalum powder.

The positive electrode body may have the dielectric layer formed on a surface thereof. The dielectric layer may be formed by oxidizing the surface of the positive electrode body. For example, the dielectric layer may be formed of a dielectric material formed of tantalum oxide (Ta₂O₅), which is an oxide of tantalum forming the positive electrode body, and may be formed at a predetermined thickness on the surface of the positive electrode body.

The dielectric layer may have the solid electrolyte layer formed on a surface thereof. The solid electrolyte layer may contain one or more of a conductive polymer and manganese dioxide (MnO₂).

In a case in which the solid electrolyte layer is formed of a conductive polymer, the solid electrolyte layer may be formed on the surface of the dielectric layer by using a chemical polymerization process or an electro-polymerization process. A material of the conductive polymer is not particularly limited as long as it is a polymer having conductivity, and may include, for example, polypyrrole, polythiophene, polyaniline, or the like.

In a case in which the solid electrolyte layer is formed of MnO₂, a conductive manganese dioxide may be formed on the surface of the dielectric layer by immersing the positive electrode body having the dielectric layer formed on the surface thereof in a manganese aqueous solution such as a manganese nitrate and then decomposing the manganese aqueous solution by heating.

The carbon layer containing carbon may be disposed on the solid electrolyte layer.

The carbon layer may be formed of carbon pastes and may be formed by applying the carbon pastes in which conductive carbon material powder such as natural graphite, carbon black, or the like, are dispersed in water or an organic solvent in a state in which the conductive carbon material powder is mixed with a binder, a dispersing agent, or the like, onto the solid electrolyte layer.

The negative electrode layer containing a conductive metal may be disposed on the carbon layer in order to improve electrical connectivity with the negative electrode terminal, wherein the conductive metal contained in the negative electrode layer may be Ag.

The tantalum capacitor may have, for example, a structure in which an internal lead frame is absent, but is not particularly limited thereto.

According to an exemplary embodiment of the present inventive concept, the multilayer ceramic capacitor 110 and the tantalum capacitor 120 may be connected in parallel with each other.

According to an exemplary embodiment of the present inventive concept, due to a structure of the composite electronic component including the composite body 130 in which the multilayer ceramic capacitor 110 and the tantalum capacitor 120 are coupled to each other, an excellent acoustic noise reduction effect may be achieved, high capacitance may be provided, equivalent series resistance (ESR)/equivalent series inductance (ESL) may be relatively low, direct current (DC)-bias characteristics may be improved, and a chip thickness may be relatively low.

The tantalum capacitor may provide high capacitance, may have excellent DC-bias characteristics, and may not generate acoustic noise at the time of being mounted on a board.

On the other hand, the tantalum capacitor may have an issue of relatively high ESR.

Meanwhile, despite relatively low ESR and ESL, the multilayer ceramic capacitor may have relatively poor DC-bias characteristics and may have difficulty in providing high capacitance as compared to those of the tantalum capacitor.

In addition, the multilayer ceramic capacitor may have issues in that a chip thickness is great and acoustic noise is generated at the time of mounting of the multilayer ceramic capacitor on the board.

However, since the composite electronic component 100 according to an exemplary embodiment of the present inventive concept includes the composite body 130 in which the multilayer ceramic capacitor 110 and the tantalum capacitor 120 are coupled to each other, relatively high ESR, a disadvantage of the tantalum capacitor, may be decreased.

In addition, deterioration of the DC-bias characteristics, a disadvantage of the multilayer ceramic capacitor, may be alleviated, and the relatively great chip thickness may be decreased.

In addition, according to an exemplary embodiment of the present inventive concept, the multilayer ceramic capacitor that generates acoustic noise at the time of being mounted on the board and the tantalum capacitor that does not generate acoustic noise at the time of being mounted on the board may be coupled to each other at a predetermined volume ratio, whereby the excellent acoustic noise reduction effect may be achieved.

According to an exemplary embodiment of the present inventive concept, as illustrated in FIGS. 1 and 2, the tantalum wire 121 may be led out from a central portion of the body part 122 of the tantalum capacitor, but may be disposed to be biased, that is, offset, towards one side of the body part 122.

Although not illustrated, the tantalum wire 121 may have an overall straight line shape.

According to an exemplary embodiment of the present inventive concept, in order to secure a space in which the multilayer ceramic capacitor is disposed, the tantalum capacitor 120 may have a structure in which the tantalum wire 121 is biased and offset towards one side of the body part 122 of the tantalum capacitor.

According to an exemplary embodiment of the present inventive concept, the multilayer ceramic capacitor 110 may be disposed in a space between the tantalum wire 121 disposed to be offset and one surface of the body part 122 of the tantalum capacitor from which the tantalum wire is led out.

The multilayer ceramic capacitor 110 may be disposed in the space between the tantalum wire 121 and one surface of the body part 122 in a direction opposite to a direction in which the tantalum wire 121 is offset.

Since a surplus space between the tantalum wire 121 and one surface of the body part 122 is formed to be relatively great in the direction opposite to the direction in which the tantalum wire 121 is offset, in the case in which the multilayer ceramic capacitor 110 is disposed in the space between the tantalum wire 121 and one surface of the body part 122 in the direction opposite to the direction in which the tantalum wire 121 is offset, space efficiency may be further improved, and a size of the multilayer ceramic capacitor 100 disposed in the surplus space may be allowed to be increased.

The tantalum wire 121 and the multilayer ceramic capacitor 110 may be disposed to be spaced apart from each other by a predetermined interval in order to prevent electrical short-circuits therebetween.

The tantalum wire 121 may need to be lead out from the body part 122 by a predetermined length in order to prevent the electrical short-circuits.

In the case in which the tantalum wire 121 is disposed to be offset towards one side of the body part 122 as in an exemplary embodiment of the present inventive concept, a relatively great space between the tantalum wire 121 and one surface of the body part 122 may be secured on one side of the tantalum wire 122 than in the case in which the tantalum wire 121 is disposed in the central portion of the body part 122, whereby the multilayer ceramic capacitor 110 may be disposed in the space between the tantalum wire 121 and one surface of the body part 122 secured on one side of the tantalum wire 122.

For example, in the case in which the tantalum wire is disposed in the central portion of the body part, the space between the tantalum wire 121 and one surface of the body part 122 may be divided into both sides of the tantalum wire. On the other hand, in the case in which the tantalum wire is disposed to be offset towards one side of the body part, space efficiency around the tantalum wire may be improved.

Therefore, effects such as an increase in capacitance and a decrease in ESR of the composite electronic component may be obtained.

As described in an exemplary embodiment of the present inventive concept, in order to secure the space between the tantalum wire 121 and one surface of the body part 122 in which the multilayer ceramic capacitor 110 is disposed at one side of the tantalum wire 121, the tantalum capacitor 120 may be connected to the positive electrode terminal 161 and the negative electrode terminal 162 without using the lead frame.

According to an exemplary embodiment of the present inventive concept, the composite electronic component in which the multilayer ceramic capacitor is disposed in a surplus space of an assembled structure of the tantalum capacitor that does not include the lead frame may be connected to the tantalum capacitor in parallel, thereby providing relatively high capacitance.

According to an exemplary embodiment of the present inventive concept, the second external electrode 131 of the multilayer ceramic capacitor may be connected to the body part 122 of the tantalum capacitor 122.

For example, the second external electrode 132 of the multilayer ceramic capacitor may be connected to one surface of the body part 122 from which the tantalum wire 121 is led out.

The second external electrode 132 of the multilayer ceramic capacitor and the body part 122 of the tantalum capacitor may be connected to each other by a direct contact therebetween or may be connected to each other by applying conductive pastes (not illustrated) therebetween.

According to an exemplary embodiment of the present inventive concept, as illustrated in FIG. 2, the multilayer ceramic capacitor 110 and the tantalum capacitor 120 may be disposed on the insulating sheet 140.

The insulating sheet 140 is not particularly limited as long as it has an insulation property, but may be manufactured using an insulating material such as a ceramic based material, or the like.

The molding part 150 may cover the composite 130 including the multilayer ceramic capacitor 110 and the tantalum capacitor 120, and the upper surface of the insulating sheet 140 having the multilayer ceramic capacitor and the tantalum capacitor disposed thereon.

The molding part 150 may protect the multilayer ceramic capacitor 110 and the tantalum capacitor 120 from an external environment, and may be mainly formed of an epoxy or silica based epoxy molding compound (EMC), or the like. However, the type of material forming the molding part 150 is not limited thereto.

The composite electronic component according to an exemplary embodiment of the present inventive concept may be provided as a single component in which the multilayer ceramic capacitor 110 and the tantalum capacitor 120 are coupled to each other, due to the molding part 150.

According to an exemplary embodiment of the present inventive concept, the composite electronic component may include the positive electrode terminal 161 and the negative electrode terminal 162 electrically connected to the multilayer ceramic capacitor and/or the tantalum capacitor.

According to an exemplary embodiment of the present inventive concept, the tantalum wire 121 may be exposed to a first side surface of the molding part 150 in a length direction of the molding part 150, and may be connected to the positive electrode terminal 161.

In the tantalum capacitor 120, that is, a tantalum capacitor having a structure in which an internal lead frame is absent, the tantalum wire 121 may be exposed to the first side surface of the molding part 150 in the length direction of the molding part 150, thereby providing capacitance as high as possible as compared to a structure according to the related art.

Connection conductor parts 141 and 142 may be disposed on one or more of upper and lower surfaces of the insulating sheet 140.

The connection conductor parts 141 and 142 may have any shape as long as they contain conductive materials for electrically connecting the positive and negative electrode terminals 161 and 162 outside the molding part and the composite body inside the molding part to each other, as will be described hereinbelow.

The positive electrode terminal and the first external electrode, and the negative electrode terminal and the body part may be connected to each other through the connection conductor parts 141 and 142, respectively.

For example, as illustrated in FIG. 3, the connection conductor parts 141 and 142 may be conductive resin parts formed by hardening conductive resin pastes.

The conductive resin parts 141 and 142 may contain a conductive particle and a base resin.

The conductive particle may be a Ag particle, but is not limited thereto, and the base resin may be a thermosetting resin, for example, an epoxy resin.

In addition, the conductive resin parts may contain Cu as a conductive metal, but is not necessarily limited thereto.

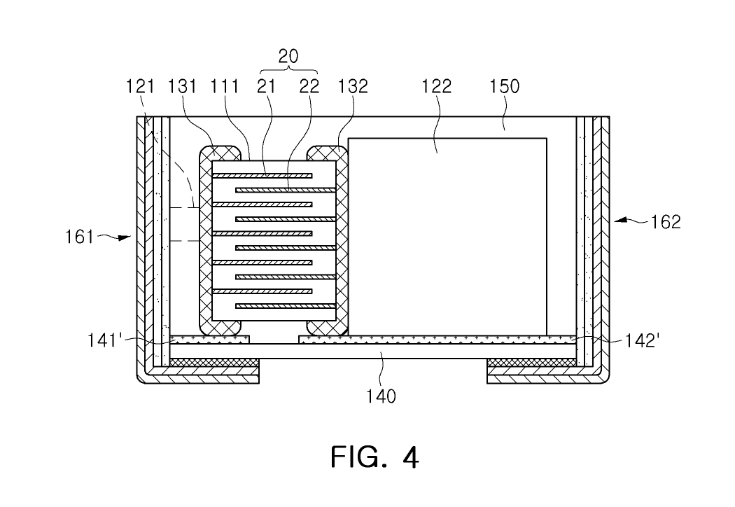

FIG. 4 is a cross-sectional view of the composite electronic component illustrating a modified example of a connection conductor part of a composite electronic component according to an exemplary embodiment of the present inventive concept.

As illustrated in FIG. 4, connection conductor parts 141′ and 142′ may have shapes of metal pads, but the shape of the connection conductor parts 141′ and 142′ is not limited thereto.

In addition, the metal pads 141′ and 142′ may contain Cu, but are not necessarily limited thereto.

The metal pads may include a first metal pad 141′ connected to the first external electrode 131 to be thereby exposed to one side surface of the molding part 150, and a second metal pad 142′ connected to the body part 122 to be thereby exposed to the other side surface of the molding part 150.

The second metal pad 142′ may be extended to be connected to a lower surface of the body part 122 and the second external electrode 132.

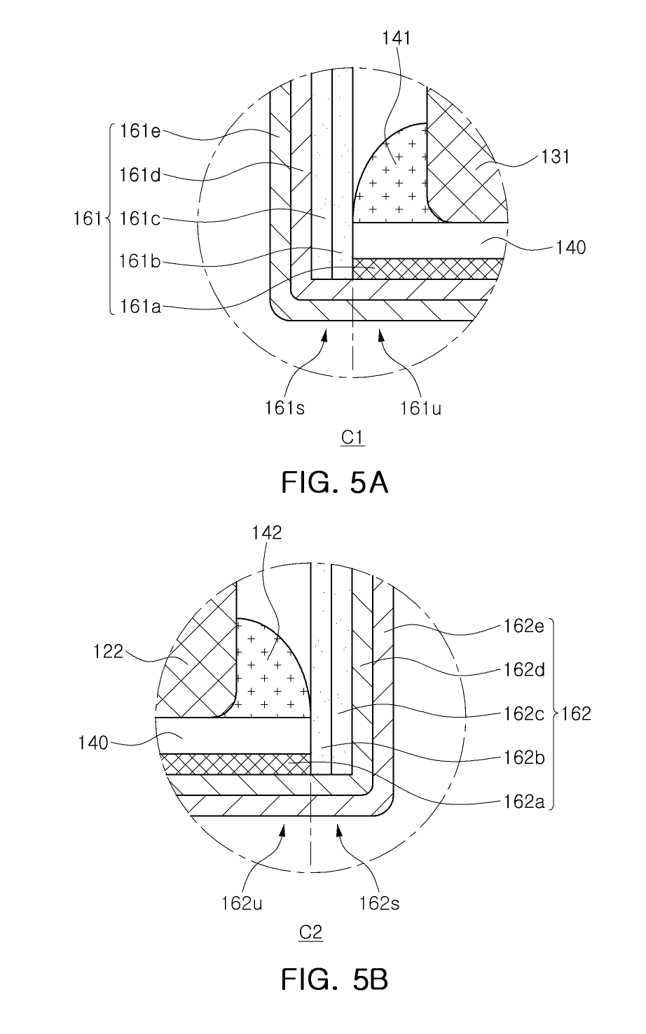

FIGS. 5A and 5B are enlarged views of regions C1 and C2 of FIG. 3.

Referring to FIGS. 3, 5A, and 5B, the electrode terminals may include the positive electrode terminal 161 and the negative electrode terminal 162.

The positive electrode terminal 161 may be disposed on the first side surface of the molding part 150 in the length direction of the molding part 150 and the lower surface of the insulating sheet 140, and may be connected to the tantalum wire 121 and the first external electrode 131.

The negative electrode terminal 162 may be disposed on the second side surface of the molding part 150 in the length direction of the molding part 150 and the lower surface of the insulating sheet 140, and may be connected to the body part 121 of the tantalum capacitor 120.

The positive electrode terminal 161 and the first external electrode 131 may be connected to each other through one of the connection conductor parts 141 and 142, that is, the connection conductor part 141, and the negative electrode terminal 162 and the body part 122 may be connected to each other through the other of the connection conductor parts, that is, the connection conductor part 142.

According to an exemplary embodiment of the present inventive concept, the positive electrode terminal 161 may be extended from the first side surface of the molding part 150 in the length direction the molding part 150 onto a portion of the lower surface of the insulating sheet 140, the negative electrode terminal 162 may be extended from the second side surface of the molding part 150 in the length direction the molding part 150 onto a portion of the lower surface of the insulating sheet 140, and the positive electrode terminal 161 and the negative electrode terminal 162 may be formed on the lower surface of the insulating sheet 140 to be spaced apart from each other.

The positive electrode terminal 161 may include a positive electrode side surface terminal part 161s disposed on the side surface of the molding part 150 and a positive electrode lower surface terminal part 161u disposed on the lower surface of the insulating sheet 140, and the negative electrode terminal 162 may include a negative electrode side surface terminal part 162s disposed on the side surface of the molding part 150 and a negative electrode lower surface terminal part 162u disposed on the lower surface of the insulating sheet 140.

According to an exemplary embodiment of the present inventive concept, the positive electrode terminal 161 may include a lower surface base layer 161a, side surface base layers 161b and 161c connected to the lower surface base layer 161a, and plating layers 161d and 161e disposed to enclose the lower surface base layer 161a and the side surface base layers 161b and 161c.

In addition, the negative electrode terminal 162 may include a lower surface base layer 162a, side surface base layers 162b and 162c connected to the lower surface base layer 162a, and plating layers 162d and 162e disposed to enclose the lower surface base layer 162a and the side surface base layers 162b and 162c.

Although the lower surface base layers 161a and 162a are illustrated as single layers, respectively, and the side surface base layers 161b, 161c, and the side surface base layers 162b, and 162c are illustrated as two separate layers, respectively, in FIG. 5A and FIG. 5B the disposition of the layers is not necessarily limited thereto, but may be provided in various manners.

The positive electrode terminal 161 and the negative electrode terminal 162 may be formed by performing processes of dry-depositing, for example, sputtering, and plating at least one of chromium (Cr), titanium (Ti), Cu, Ni, Pd, and gold (Au), forming a metal layer, and etching the metal layer, but the process of forming the positive electrode terminal 161 and the negative electrode terminal 162 is not limited thereto.

In addition, the positive electrode terminal 161 and the negative electrode terminal 162 may be formed by forming the lower surface terminal parts 161u and then forming the side surface terminal parts 161s to be connected to the lower surface terminal parts 161u.

The lower surface base layers 161a and 162a may be formed by etching, but the manner of forming the lower surface base layers 161a and 162a is not necessarily limited thereto.

The lower surface base layers 161a and 162a may be disposed on the lower surface of the insulating sheet 140, and may have patterns formed by applying a metal thin film to the lower surface of the insulating sheet 140 and then performing an etching process in order to form the lower surface base layers 161a and 162a.

The lower surface base layers 161a and 162a are not particularly limited, and may contain, for example, Cu.

In a case in which the lower surface base layers 161a and 162a are formed of Cu, an excellent connection of the lower surface base layers 161a and 162a to the positive electrode side surface terminal part 161s and the negative electrode lower surface terminal part 162u formed by a separate process may be obtained, and relatively high electrical conductivity may be obtained therebetween.

Meanwhile, the side surface base layers 161b, 161c, 162b, and 162c may be formed by a deposition process, for example, a sputtering process.

The side surface base layers 161b, 161c, 162b, and 162c are not particularly limited, but the side surface base layers 161b and 161c may be formed of two layers of an inner side and an outer side, respectively, and the side surface base layers 162b and 162c may be formed of two layers of an inner side and an outer side, respectively.

The inner side surface base layer 161b and 162b from among the side surface base layers 161b, 161c, 162b, and 162c may contain one or more of Cr or Ti, may be formed by the sputtering process, and may be connected to the lower surface base layers 161a and 162a.

The outer side surface base layer 161c and 162c from among the side surface base layers 161b, 161c, 162b, and 162c may contain Cu and may be formed by the sputtering process.

According to an exemplary embodiment of the present inventive concept, since the body part 122 of the tantalum capacitor 120 and the second external electrode 132 of the multilayer ceramic capacitor 110 are connected to each other, the composite electronic component 100 that does not require a separate insulating layer for securing insulation between the tantalum capacitor 120 and the multilayer ceramic capacitor 110 may be provided.

According to an exemplary embodiment of the present inventive concept, the tantalum capacitor 120 and the multilayer ceramic capacitor 110 may be connected in parallel with each other on the insulating sheet 140 used to form a positive electrode terminal and a negative electrode terminal of a frameless tantalum capacitor that does not include an internal lead frame.

According to an exemplary embodiment of the present inventive concept, the composite electronic component in which impedance of the tantalum capacitor appears in a relatively low frequency band and impedance of the multilayer ceramic capacitor appears in a relatively high frequency band may be provided.

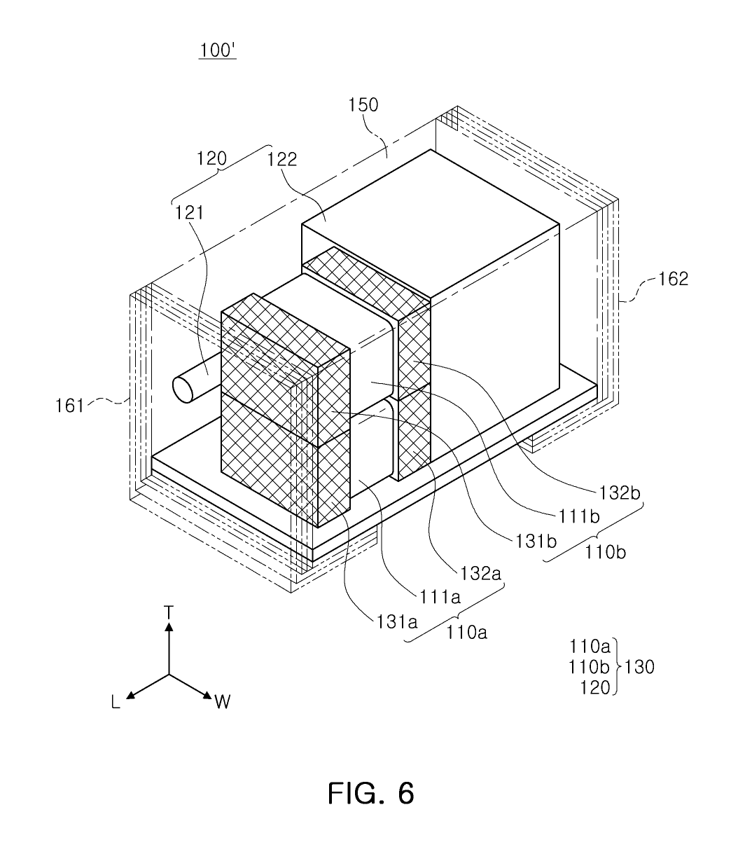

FIG. 6 is a perspective view schematically illustrating a composite electronic component according to another exemplary embodiment of the present inventive concept.

Referring to FIG. 6, in a composite electronic component according to another exemplary embodiment of the present inventive concept, the tantalum wire 121 may be disposed to be biased and offset towards one side of the body part 122 of the tantalum wire 121, and two or more multilayer ceramic capacitors 110a and 110b may be disposed in a space between the tantalum wire 121 and one surface of the body part 122 secured by a structure in which the tantalum wire 121 is offset. For example, a first multilayer ceramic capacitor 110a may be disposed on the insulating sheet, and a second multilayer ceramic capacitor 110b may be disposed on the first multilayer ceramic capacitor 110a.

In a case in which two or more multilayer ceramic capacitors are disposed, the tantalum capacitor and the two or more multilayer ceramic capacitors may be connected in parallel with each other.

The composite electronic component according to the other exemplary embodiment of the present inventive concept may include the molding part 150 disposed to enclose the tantalum capacitor and the multilayer ceramic capacitors.

Since a description of other contents of the composite electronic component according to the other exemplary embodiment of the present inventive concept is identical to the description of the contents of the composite electronic component according to the exemplary embodiment of the present inventive concept described above, a repeated description thereof will be omitted for conciseness.

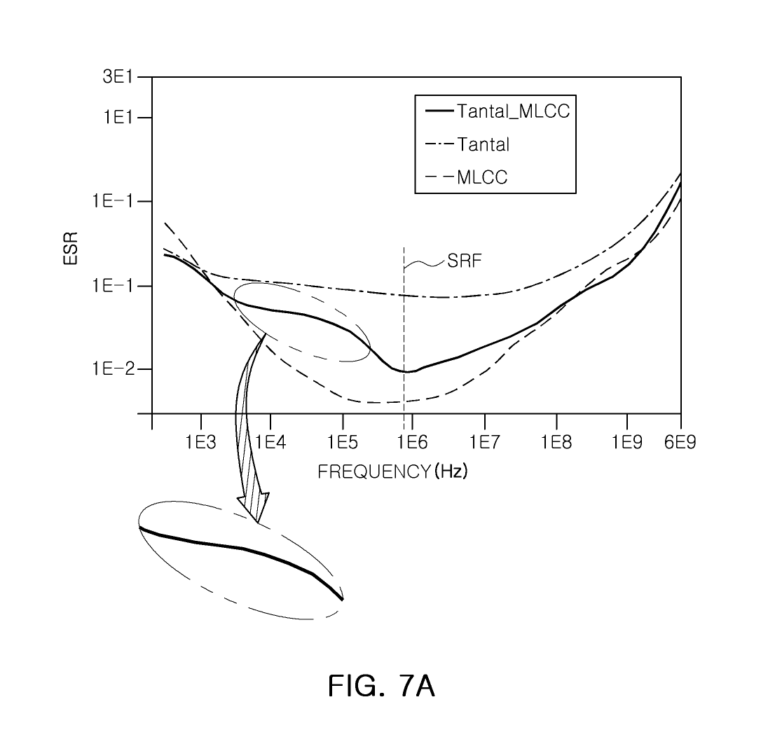

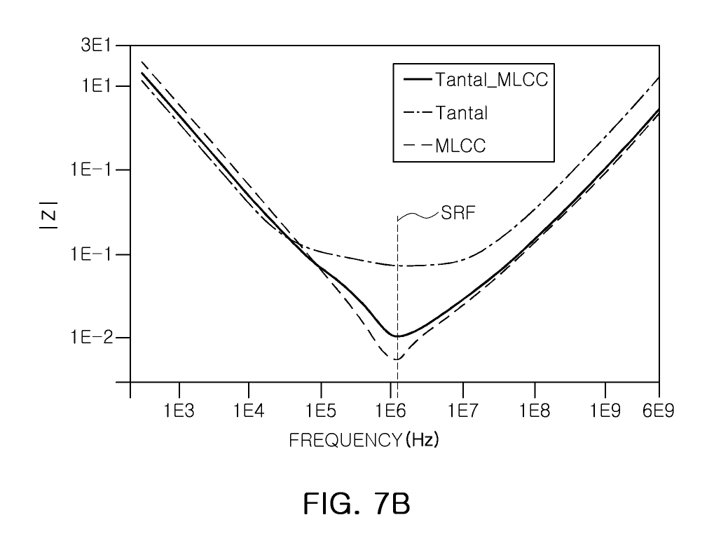

FIGS. 7A and 7B are graphs illustrating ESR versus a frequency of a composite electronic component according to Inventive Example and Comparative Example, and impedance versus a frequency of a composite electronic component according to Inventive Example and Comparative Example, respectively.

Referring to FIGS. 7A and 7B, in the graphs illustrating ESR versus the frequency of the input signal and impedance versus the frequency of the input signal, respectively, in the composite electronic component according to Inventive Example, inflection points of ESR and impedance may be generated in at least one of frequency bands prior to and subsequent to an SRF.

That is, according to Inventive Example, in the graph illustrating impedance versus the frequency, impedance of the tantalum capacitor may appear in a relatively low frequency band, and impedance of the multilayer ceramic capacitor may appear in a relatively high frequency band.

Therefore, in the graphs illustrating ESR versus the frequency of the input signal and impedance versus the frequency of the input signal, respectively, the inflection points of ESR and impedance may be generated in at least one of the frequency bands prior to and subsequent to the SRF.

The inflection points of ESR and impedance may be generated in at least one of the frequency bands prior to and subsequent to the SRF, or may be generated in both of the frequency bands prior to and subsequent to the SRF.

Since the inflection points of ESR and impedance are generated in at least one of the frequency bands prior to and subsequent to the SRF, the composite electronic component according to Inventive Example may provide relatively low ESR.

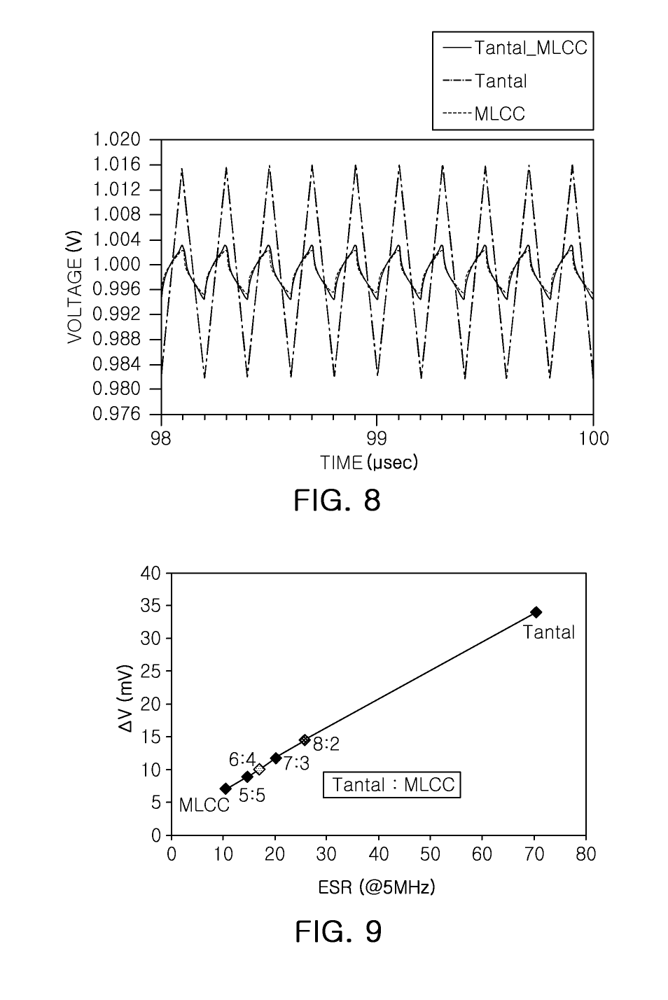

FIG. 8 is a graph illustrating an output voltage versus time according to Inventive Example and Comparative Example.

Referring to FIG. 8, it may be appreciated that a voltage ripple of Inventive Example is significantly decreased as compared to that of Comparative Example in which only the tantalum capacitor is used, and is substantially similar to that of Comparative Example in which only the multilayer ceramic capacitor is used.

That is, it may be appreciated that in the case of Comparative Example in which only the tantalum capacitor is used, a voltage ripple is 34 millivolts (mV), while in the case of Inventive Example, a voltage ripple is decrease to 9 mV, which is similar to that (7 mV) of Comparative Example in which only the multilayer ceramic capacitor is used.

FIG. 9 is a graph illustrating a voltage ripple (ΔV) as compared to ESR based on a volume ratio between a multilayer ceramic capacitor and a tantalum capacitor in a composite electronic component according to an exemplary embodiment of the present inventive concept.

Referring to FIG. 9, it may be appreciated that in an exemplary embodiment of the present inventive concept, in a case in which a volume ratio between the tantalum capacitor and the multilayer ceramic capacitor coupled to each other is 5:5 to 7:3, an electronic component having relatively low ESR, a relatively low voltage ripple (ΔV), and relatively high capacitance may be achieved.

Board Having Composite Electronic Component

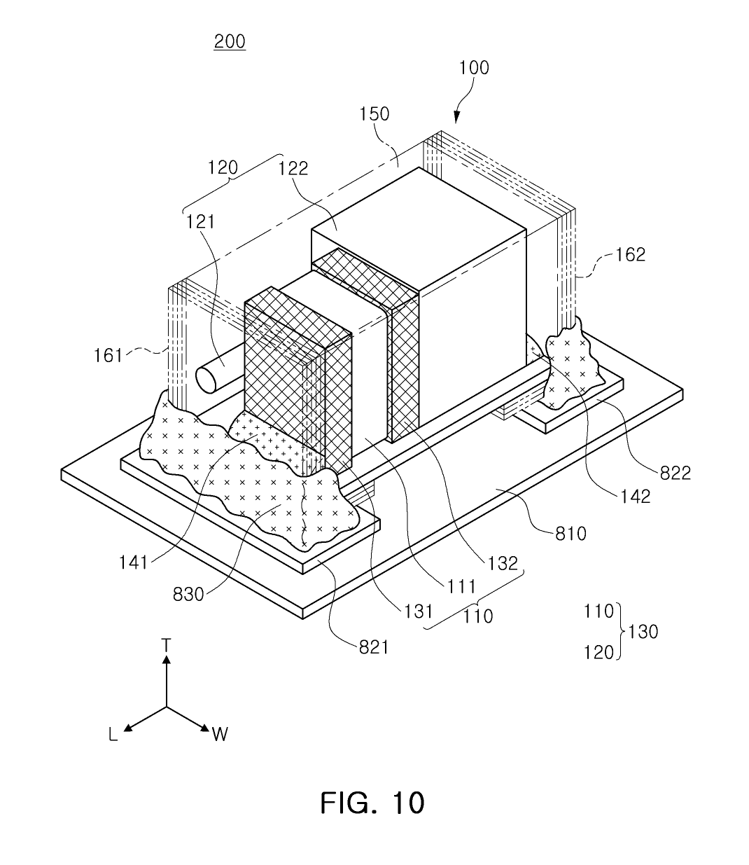

FIG. 10 is a perspective view illustrating a form in which the composite electronic component of FIG. 1 is mounted on a PCB.

Referring to FIG. 10, a board 200 having a composite electronic component according to another exemplary embodiment may include a PCB 810 on which electrode pads 821 and 822 are disposed, the composite electrode component 100 mounted on the PCB 810, and solders 830 connecting the electrode pads 821 and 822 and the composite electronic component 100 to each other.

The board 200 having the composite electronic component according to the present exemplary embodiment may include the PCB 810 having the composite electronic component 100 mounted thereon and two or more electrode pads 821 and 822 formed on an upper surface of the PCB 810.

The electrode pads 821 and 822 may include first and second electrode pads 821 and 822 connected to the positive electrode terminal 161 and the negative electrode terminal 162 of the composite electronic component, respectively.

Here, the positive electrode terminal 161 and the negative electrode terminal 162 of the composite electronic component may be electrically connected to the PCB 810 by the solders 830 in a state in which the solders 830 are positioned on the first and second electrode pads 821 and 822 to be in contact with the first and second electrode pads 821 and 822, respectively.

As set forth above, according to exemplary embodiments of the present inventive concept, the composite electronic component having an excellent acoustic noise reduction effect may be provided.

In addition, according to exemplary embodiments of the present inventive concept, the composite electronic component capable of providing high capacitance, having relatively low ESR/ESL, improved DC-bias characteristics, and a relatively low chip thickness may be provided.

Further, according to exemplary embodiments of the present inventive concept, the composite electronic component having improved space efficiency may be provided.

While exemplary embodiments have been shown and described above, it will be apparent to those skilled in the art that modifications and variations could be made without departing from the scope of the invention as defined by the appended claims.

What is claimed is:

1. A composite electronic component comprising:
an insulating sheet;
connection conductor parts disposed on one or more of upper and lower surfaces of the insulating sheet;
a composite body disposed on the insulating sheet and including a tantalum capacitor and a multilayer ceramic capacitor (MLCC) coupled to each other;
a molding part disposed to enclose the composite body; and
a positive electrode terminal disposed on a first side surface of the molding part in a length direction of the molding part and a lower surface of the molding part, and a negative electrode terminal disposed on a second side surface of the molding part in the length direction of the molding part and the lower surface of the molding part,
wherein the tantalum capacitor includes a body part containing a material formed of sintered tantalum powder and a tantalum wire offset towards one side of the body part and partially embedded in the body part, the multilayer ceramic capacitor includes a ceramic body in which a plurality of dielectric layers and internal electrodes are alternatingly disposed and first and second external electrodes disposed on outer surfaces of the ceramic body, and
the multilayer ceramic capacitor is disposed between one surface of the body part from which the tantalum wire is led out and the tantalum wire exposed from the body part.

2. The composite electronic component of claim 1, wherein the multilayer ceramic capacitor is disposed in a direction opposite to a direction in which the tantalum wire is offset.

3. The composite electronic component of claim 1, wherein the first external electrode of the multilayer ceramic capacitor and the tantalum wire of the tantalum capacitor are connected to the positive electrode terminal.

4. The composite electronic component of claim 1, wherein the second external electrode of the multilayer ceramic capacitor is connected to the body part of the tantalum capacitor.

5. The composite electronic component of claim 1, wherein the tantalum wire is exposed to the first side surface of the molding part in the length direction of the molding part.

6. The composite electronic component of claim 1, wherein in a graph illustrating equivalent series resistance (ESR) versus a frequency of an input signal, an inflection point of the ESR is generated in at least one of frequency bands prior to and subsequent to a self resonant frequency (SRF).

7. The composite electronic component of claim 1, wherein the positive electrode terminal and the negative electrode terminal include a lower surface base layer, side surface base layers connected to the lower surface base layer, and plating layers disposed to enclose the lower surface base layer and the side surface base layers.

8. The composite electronic component of claim 7, wherein the lower surface base layer is formed by etching.

9. The composite electronic component of claim 7, wherein the side surface base layer is formed by deposition.

10. The composite electronic component of claim 1, wherein the connection conductor part contains a conductive resin.

11. The composite electronic component of claim 1, wherein the connection conductor part includes a metal pad.

12. The composite electronic component of claim 1, wherein the multilayer ceramic capacitor includes a first multilayer ceramic capacitor and a second multilayer ceramic capacitor disposed on the first multilayer ceramic capacitor.

13. The composite electronic component of claim 1, wherein a volume ratio between the tantalum capacitor and the multilayer ceramic capacitor coupled to each other (tantalum capacitor:multilayer ceramic capacitor) is 2:8 to 9:1.

14. A board having a composite electronic component, comprising:
a printed circuit board (PCB) on which electrode pads are disposed;
a composite electronic component mounted on the PCB; and
solders connecting the electrode pads and the composite electronic component to each other,
wherein the composite electronic component includes: an insulating sheet, connection conductor parts disposed on one or more of upper and lower surfaces of the insulating sheet, a composite body disposed on the insulating sheet and including a tantalum capacitor and a multilayer ceramic capacitor (MLCC) coupled to each other, a molding part disposed to enclose the composite body, and a positive electrode terminal disposed on a first side surface of the molding part in a length direction of the molding part and a lower surface of the molding part, and a negative electrode terminal disposed on a second side surface of the molding part in the length direction of the molding part and the lower surface of the molding part, and the tantalum capacitor includes a body part containing a material formed of sintered tantalum powder and a tantalum wire offset towards one side of the body part and partially embedded in the body part, the multilayer ceramic capacitor includes a ceramic body in which a plurality of dielectric layers and internal electrodes are alternatingly disposed and first and second external electrodes disposed on respective outer surfaces of the ceramic body, and the multilayer ceramic capacitor is disposed between one surface of the body part from which the tantalum wire is led out and the tantalum wire exposed from the body part.

15. The board having a composite electronic component of claim 14, wherein the multilayer ceramic capacitor is disposed in a direction opposite to a direction in which the tantalum wire is offset.

16. The board having a composite electronic component of claim 14, wherein the first external electrode of the multilayer ceramic capacitor and the tantalum wire of the tantalum capacitor are connected to the positive electrode terminal.

17. The board having a composite electronic component of claim 14, wherein the second external electrode of the multilayer ceramic capacitor is connected to the body part of the tantalum capacitor.

18. The board having a composite electronic component of claim 14, wherein the tantalum wire is exposed to the first side surface of the molding part in the length direction of the molding part.

19. The board having a composite electronic component of claim 14, wherein the multilayer ceramic capacitor includes a first multilayer ceramic capacitor and a second multilayer ceramic capacitor disposed on the first multilayer ceramic capacitor.

20. The board having a composite electronic component of claim 14, wherein a volume ratio between the tantalum capacitor and the multilayer ceramic capacitor coupled to each other (tantalum capacitor:multilayer ceramic capacitor) is 2:8 to 9:1.
